(19) United States
(12) Patent Application Publication
(10) Pub. No.: US 2007/0211453 A1
(43) Pub. Date: Sep. 13, 2007

(54) Holiday lighting track system

(76) Inventor: Chris Hamburger, Danville, CA (US)

Correspondence Address: John Bargero, PO BOX 471857, San Francisco, CA, 94123, US

(21) Appl. No.: 11/369,540

(22) Filed: Mar. 8, 2006

(51) Int. Cl. F21S 8/00; F21V 21/00

(52) U.S. Cl. 362/145; 362/249

(57) ABSTRACT

A device that is permanently installed on the exterior of building that allows for the easy installation and removal of Christmas lights or other such string lighting systems. The device is rectangular shaped channel with a grove removed from the front face to allow for the insertion and mounting of Christmas lights via clips contained on the lamp socket base.

### BACKGROUND

This invention relates generally to decorative Christmas lighting displays, and more particularly to a devise for installing strands of lights on the exterior of buildings and other structures.

During the Christmas holiday season, many people decorate the exterior of their homes or offices with Christmas lights. These lights typically are arranged as a string of lights along a power cord and requires that this cord be anchored to the structure at certain intervals to provide a neat appearance, or each individual light along the strand can be mounted to the structure via a spring clip that is usually located on each light socket. Either task is time consuming because they require that the installer affix either the light or the cord to a location and then move to the next location to affix the next light or section of the light stringer. Since lights are typically installed at relatively high elevations, such as rooflines, a ladder or means of elevating, such as a lift, must be used. Installation of the lights requires constant repositioning of the elevating device, which can be very time consuming, particularly at very high elevations such as multistory commercial buildings such as apartment complexes and office buildings.

In order to overcome this issue of labor intensive installation one common approach has been to mount the lights on the building permanently. Although, this is a solution it does have some drawback. These drawbacks include the unsightliness of having Christmas lights up in the off-season or the potential damage or weathering of the bulbs and wires by such elements as sun exposure and vermin. The lights may be damaged and become dirty if left up all year long and thus not function properly when needed during the Christmas season. In addition, permanently mounting the lights to the building does not allow for the easy change of either light configuration, such as color or light style.

Another approach is to permanently install several retaining clips on the exterior surface of the building. This reduces the installation time of subsequent installation, but still is rather labor intensive and has the drawback of relying on the wire to support the lights, which may get pinched or nicked during the installation and removal of the light strings. In addition, the clips are permanently attached to the structure and may be an eye sore.

One more approach is to install temporary retaining clips. This can be very time consuming due to the installation and removal each season.

There is a need for a simple device that allows for the quick and easy installation of Christmas lights on tall structures.

### SUMMARY OF THE INVENTION

The purpose of the abstract is not to define the invention, nor is it intended to limit the scope of the invention in anyway. Its purpose is to inform, on a cursory inspection, the nature and essence of the technical enclosure of the invention.

The present invention discloses a novel way of installing Christmas and ornamental lights on buildings and structures. The invention discloses a track to hold the lights which is comprised of an elongated channel and channel recess defined by a horizontal top and bottom walls joined by a vertical rear wall and a front wall depending upwards from the bottom wall. The front wall has a height less than the height of the rear wall. The result is an elongated gap between the top wall and the front wall, with a void formed in the center of the four walls. The horizontal top wall may or may not have a slight lip depending downwards towards the bottom wall.

More succinctly, the invention approximates a thin walled stick of rectangular tubing with a slot milled through one of the sides the entire length of the stick to allow the insertion of the light clip, from a side view the device approximates looks like a “c” channel with tabs extending perpendicularly towards each other from the open side flanges.

The lighting track or elongated channel can be on varied length and can be combined end to end to form a continuous channel of any desired length. The elongated channel or channels are affixed to the fascia of the structure that the lights are intended to be mounted to. The method of affixing varies and includes, but is not limited to various adhesives or mechanical fasteners such as screws, nails or rivets. A clip on or a standard Christmas light strand has a plurality of horizontally spaced lamp sockets connected by electrical wire and each socket contains a clipping mechanism. The spacing between each of the lamps can vary depending on manufacturer, but the more common configurations range from six inches to two feet between each lamp. These clips are attached to the front wall of the elongated channel. This is achieved by inserting each light clip into the elongated gap of the elongated channel with the longest portion of the clip parallel to the top wall and then rotating the light towards the bottom wall, roughly a ninety degree rotation. This will result in the light bulb orientated so that the glass tip of the bulb is pointed towards the ground. This process is repeated for each light bulb and can be done from a stationary location by simply pushing each installed light bulb away from the installer, that is in either direction along the rail parallel to the top wall. Once the entire strand of lights is loaded in to the light hanging device the strand can be extended or stretched to form the desired light spacing.

Alternatively, the lighting track or elongated channel may be mounted to the building surface in a plurality of positions, such as at an angle to correspond to the geometry of the structure, with that said it is apparent that the orientation of the light bulb will change accordingly.

In one preferred embodiment, the invention is dimensioned to accommodate commercially available Christmas lights. The front wall has a minimum height of ⅞ of an inch, which is longer than the Christmas light-hanging clip allowing insertion and rotation of the light. The top and bottom walls have a minimum height to allow for an internal void of not less than 7/16 of an inch to accommodate the light-hanging clip.

Important objectives of the present invention include an elongate device that allows for the quick installation and removal of Christmas lights which is permanently mounted to the exterior of the structure that is attractive, simple, inexpensive to manufacture and durable against the elements.

### BRIEF DESCRIPTION OF THE DRAWINGS

Taking the following specifications in conjunction with the accompanying drawings will cause the inventions to be better understood regarding these and other features and advantages. The specifications reference the annexed drawings wherein:

FIG. 1. is a top plan view of the holiday lighting track system.

FIG. 2. is a top plan view of the holiday lighting track system with Christmas light attached.

FIG. 3 is an isometric view of the holiday lighting track system.

FIG. 4 is a front elevation view of a building and the holiday lighting track system with lights attached.

### DETAILED DESCRIPTION OF THE DRAWINGS AND PREFERRED EMBODIMENTS

While describing the invention and its embodiments, various terms will be used for the sake of clarity. These terms are intended to not only include the recited embodiments, but also all equivalents that perform substantially the same function, in substantially the same manner to achieve the same result.

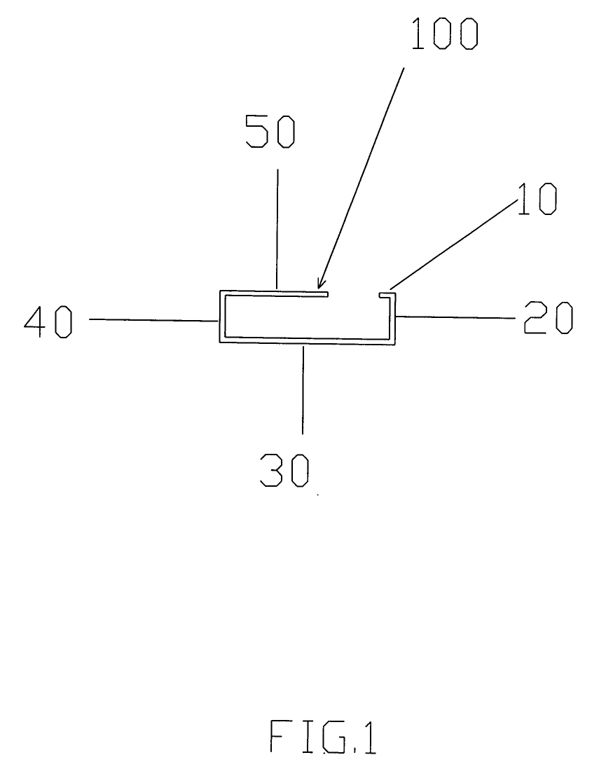

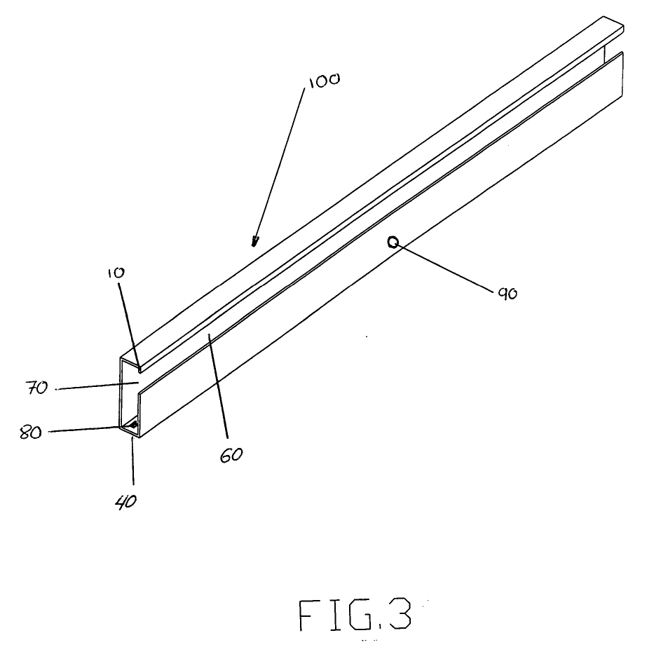

A preferred embodiment of the present invention discloses a novel holiday lighting track system for installing Christmas and ornamental lights on structures and is depicted in top plan view in FIG. 1 and indicted generally by reference number 100. The invention discloses an elongated channel defined by a horizontal top wall 20 and bottom wall 40 joined by a vertical rear wall 30 and a front wall 50 depending upwards from the bottom wall. The front wall 50 has a height less than the height of the rear wall 30. FIG. 3 shows the resulting elongated gap 60 between the top wall and the front wall, with a void 70 formed in the center of the four walls. The horizontal top wall 20 may or may not have a slight lip 10 depending downwards towards the bottom wall 40.

The elongated channel or holiday lighting track system 100 can be of varied length and can be combined end to end to form a continuous channel of any desired length. The holiday lighting track system 100 or strips are affixed to the fascia of the structure that the lights are intended to be mounted to. The method of affixing varies and includes, but is not limited to various adhesives or mechanical fasteners such as screws, nails or rivets.

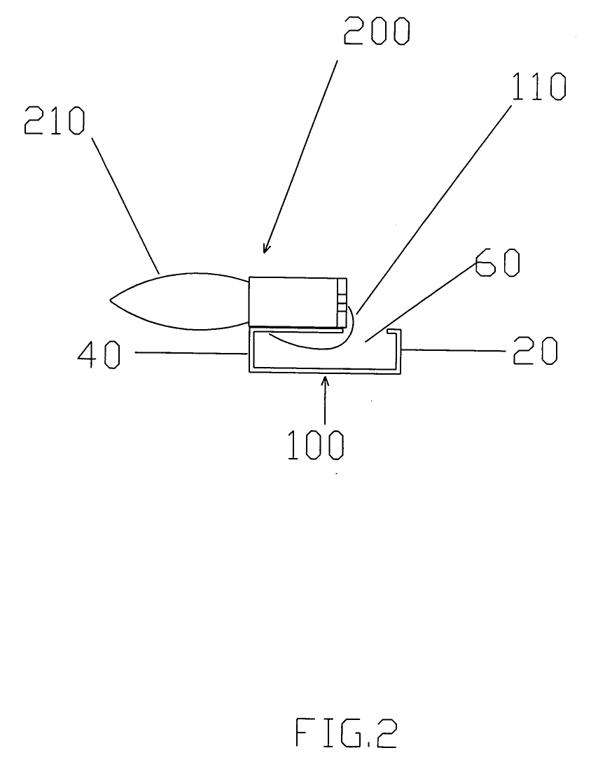

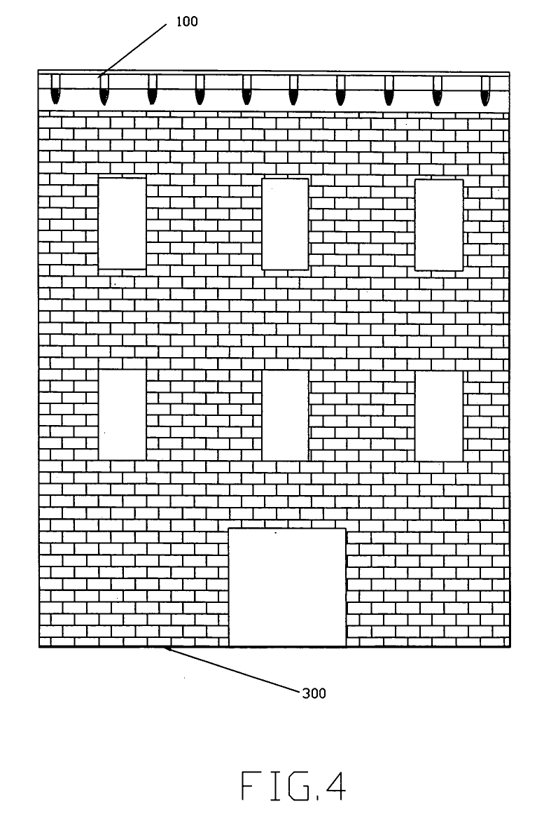

As depicted by FIG. 2, a standard Christmas light strand 200 has clips 110 attached to each light socket that are clipped onto the front wall 50 of the holiday lighting track system 100. This is achieved by inserting each light clip 110 into the elongated gap 60, depicted in FIG. 2 and FIG. 3, of the holiday lighting track system 100 or elongated channel with the longest portion of the clip 110 parallel to the top wall 20 and then rotating the light towards the bottom wall 40, roughly a ninety degree rotation. This will result in the light bulb 210 orientated so that the glass tip of the bulb is pointed towards the ground. This process is repeated for each light bulb and can be done from a stationary location by simply pushing each installed light bulb away from the installer, that is in either direction along the gap 60 parallel to the top wall 20. Once the entire strand of lights 200 is loaded into the light-hanging device 100, the strand 200 can be extended or stretched to form the desired light spacing as depicted in FIG. 4. The light hanging device 100 can be made from a variety of materials such as extruded metals, such as brass, aluminum or the like or plastic.

FIG. 3. depicts another preferred embodiment where the light hanging device 100 has predrilled or punched mounting holes 90 that transverse from the front wall 50 through the back wall 30 to allow the insertion of fasteners, such as screw or the like. FIG. 3. also depicts optional weep holes 80 that are located periodically along and through the bottom wall 40 to allow for drainage of liquid from the light hanging device 100.

The invention has been described in terms of the preferred embodiment. One skilled in the art will recognize that it would be possible to construct the elements of the present invention from a variety of means and to modify the placement of the components in a variety of ways. While the embodiments of the invention have been described in detail and shown in the accompanying drawings, it will be evident that various further modifications are possible without departing from the scope of the invention as set forth in the following claims.

I claim:

1. A device for installing clip on lights on the exterior surface of a structure comprising:
a horizontal top wall, and a bottom wall joined by a vertical rear wall and a front wall depending upwards from the bottom wall, the front wall having a height less than the height of the rear wall thereby forming an elongated gap between the top wall and the front wall, with a void formed in the center of the four walls for receiving clip portion of said lights; and a means to affix said device to said exterior surface.

2. The device of claim 1, wherein the horizontal top wall has a slight lip depending downwards towards the bottom wall.

3. The device of claim 1, wherein the bottom wall has a plurality of perforations to allow for the drainage of liquids.

4. The device of claim 1, wherein the front wall and rear wall has a plurality of perforations dimensioned to accommodate mounting fasteners.

5. A device for securing clip-on type Christmas lights to the exterior surface of structures comprising:
a section of thin walled rectangular tubing with a top face, a bottom face, front face and a back face wherein said front face has a groove cut through it forming a slotted opening parallel to the top and bottom face to allow insertion of Christmas light clip and said back face is attached to the exterior surface by fasteners or adhesive.

6. The device of claim 5, wherein the front and rear face has a plurality of perforations dimensioned to accommodate mounting fasteners.

7. The device of claim 5, wherein the bottom face has a plurality of perforations to allow for the drainage of liquids.
